(19) United States
(12) Patent Application Publication
(10) Pub. No.: US 2024/0359447 A1
(43) Pub. Date: Oct. 31, 2024

(54) DECORATIVE SURFACE LAMINATE AND METHOD OF MANUFACTURING A DECORATIVE SURFACE LAMINATE

(71) Applicant: INTERLAM CORPORATION, Mount Airy, NC (US)

(72) Inventor: Alvin Eckenrod, Mount Airy, NC (US)

(73) Assignee: INTERLAM CORPORATION, Mount Airy, NC (US)

(21) Appl. No.: 18/289,313

(22) PCT Filed: Mar. 7, 2023
(86) PCT No.: PCT/US2023/014712

§ 371 Date: Nov. 2, 2023

Related U.S. Application Data
(60) Provisional application No. 63/328,036, filed on Apr. 6, 2022.

(51) Int. Cl. B32B 29/00; B32B 21/06; B32B 37/06; B32B 37/10; B32B 37/24; B32B 38/08; B44C 5/04

(52) U.S. Cl. CPC B32B 29/005; B32B 21/06; B32B 37/06; B32B 37/10; B32B 37/24; B32B 38/08; B44C 5/0415; B32B 2037/243; B32B 2255/12; B32B 2260/028; B32B 2260/046; B32B 2264/0285; B32B 2264/105; B32B 2264/201; B32B 2307/4023; B32B 2307/72; B32B 2307/7376; B32B 2309/02; B32B 2309/105; B32B 2309/12; B32B 2311/00; B32B 2317/122; B32B 2317/125; B32B 2317/16; B32B 2361/00; B32B 2367/00; B32B 2451/00

(57) ABSTRACT

A method of manufacturing a decorative surface laminate incorporates a sheet of cellulose-based inclusion paper. The inclusion paper includes a print surface having a porosity greater than 1.25% and a decorative ink finish digitally printed directly onto the print surface of the inclusion paper. Multiple sheets of backing paper are stacked with the inclusion paper, such that the backing paper resides adjacent the inclusion paper on a side opposite the print surface. The inclusion paper and backing paper are impregnated with a thermosetting resin. Using heat and pressure, the impregnated sheets of inclusion paper and backing paper are combined to form a flexible high-density laminate panel.

### TECHNICAL FIELD AND BACKGROUND OF THE DISCLOSURE

The present disclosure relates broadly and generally to decorative surface laminates and methods of manufacturing a decorative surface laminate. In exemplary embodiments, the disclosure comprises a high-resolution customized pattern or graphic digitally printed directly onto an inclusion paper in a high pressure laminate.

High pressure laminates (or HPLs) are created through a multi-step process commonly known and understood in the art. Such products are generally made up of 3 to 8 layers of resin-impregnated kraft paper, decorative paper and a clear overlay. These layers are manufactured under 1000 kg per-square-meter of pressure, under 140° C.+ temperatures to form a flexible high-density laminated panel. Such panels are often purchased without a substrate. Attaching the laminated panel to a base, such as plywood or particle board, is a separate process—commonly referred to as “bonding” or “laying up the laminate”. The resulting HPL has exceptional durability and is heat, moisture, stain and abrasion resistant. Concepts of the present disclosure are applicable in other surface laminates including, for example, continuous pressure laminates (CPL), low pressure laminates (LPL) and thermally fused laminates (TFL).

### SUMMARY OF EXEMPLARY EMBODIMENTS

Various exemplary embodiments of the present disclosure are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

It is also noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

According to one exemplary embodiment, the present disclosure comprises a method of manufacturing a decorative surface laminate. The method includes cutting a sheet of cellulose-based inclusion paper, the inclusion paper comprising a print surface having a porosity greater than 1.25% and a decorative ink finish digitally printed directly onto the print surface of the inclusion paper. Multiple sheets of backing paper are cut and stacked with the inclusion paper, such that the backing paper resides adjacent the inclusion paper on a side opposite the print surface. The inclusion paper and backing paper are impregnated with a thermosetting resin. Using heat and pressure, the impregnated sheets of inclusion paper and backing paper are combined (e.g., fused) to form a flexible high-density laminate panel.

The term “finish” refers herein to any digitally-printed ink graphic, pattern, design, texture, color or combination of colors.

The term “inclusion paper” refers herein to a paper composition comprising numerous cut pieces of decorative natural and/or synthetic additives. Examples of decorative additives include holographic particles, metal flakes, mica flecks, sparkles, sequins, glitter, and cut pieces of metallized film, plastics, textiles, threads, flower pedals, leaves, grass, coconut husks, banana stalks and others. In one example, the inclusion paper incorporates between 10 and hundreds of individual pieces of infused additives per square inch of paper surface area. In another example, between about 10% and 50% of the entire (print side) surface area of the inclusion paper comprises decorative additives. In yet another example, between about 15% and 30% the entire (print side) surface area of the inclusion paper comprises decorative additives. In yet another example, between about 20% and 25% the entire (print side) surface area of the inclusion paper comprises decorative additives. In yet another example, up to about 100% of the entire (print side) surface area of the inclusion paper comprises decorative additives. In exemplary embodiments, the inclusions can add a decorative three-dimensional effect or surface texture not generally achievable with an ink print alone.

As used herein, the term “cellulose-based” refers to a paper composition comprising more than 50% (by weight) of cellulose fibers.

According to another exemplary embodiment, the inclusion paper comprises cellulose fibers and metallic inclusions.

According to another exemplary embodiment, the metallic inclusions comprise cut pieces of polyurethane-coated VMPET film.

According to another exemplary embodiment, the method further includes applying the laminate panel to a substrate (or “base”). The base is selected from a group consisting of solid wood, plywood, medium-density fiberboard (MDF), high-density fiberboard (HDF), and particle board.

According to another exemplary embodiment, the multiple sheets of backing paper comprise 3-8 sheets of kraft paper.

According to another exemplary embodiment, the thermosetting resin comprises one of a group consisting of phenol-formaldehyde resin and melamine-formaldehyde resin.

According to another exemplary embodiment, the step of using heat and pressure comprises simultaneously applying heat at a temperature range of between 100 degrees C. and 150 degrees C., and pressure at a pressure range of between 3 MPa (MegaPascal) and 8 MPa.

According to another exemplary embodiment, the laminate panel has a thickness less than 1.0 mm and a density greater than 1.35 g/cm3.

According to another exemplary embodiment, the print surface of the inclusion paper has a porosity of between 1.25% and 6.25%.

According to another exemplary embodiment, the print surface of the inclusion paper has a porosity of approximately 2.5%.

According to another exemplary embodiment, the liquid ink has a viscosity less than 15 millipascal-second at 32 degrees C. and a shear rate of 1,000 l/s.

In another exemplary embodiment, the present method of manufacturing a decorative surface laminate includes cutting a sheet of cellulose-based metallic inclusion paper, the metallic inclusion paper comprising a print surface having a porosity greater than 1.25%. Using a liquid dye-based ink, a decorative ink finish is digitally printed directly onto the print surface of the metallic inclusion paper. Multiple sheets of backing paper are cut and stacked with the metallic inclusion paper, such that the backing paper resides adjacent the metallic inclusion paper on a side opposite the print surface. The metallic inclusion paper and backing paper are impregnated with a thermosetting resin. Using heat and pressure, the impregnated sheets of metallic inclusion paper and backing paper are combined (e.g., fused) to form a flexible high-density laminate panel.

In yet another exemplary embodiment, the present method of manufacturing a decorative surface laminate includes cutting a sheet of cellulose-based inclusion paper, the inclusion paper comprising a print surface having a porosity greater than 1.25%. A decorative ink finish is digitally printed directly onto the print surface of the inclusion paper.

In yet another exemplary embodiment, the disclosure comprises a decorative surface laminate. The laminate incorporates a cellulose-based inclusion paper, the inclusion paper comprising a print surface having a porosity greater than 1.25%. A digitally-printed decorative ink finish is applied to the print surface of the inclusion paper. Multiple sheets of backing paper are stacked adjacent the inclusion paper and are integrally formed with the inclusion paper under heat and pressure, such that the backing paper resides adjacent the inclusion paper on a side opposite the print surface.

### BRIEF DESCRIPTION OF THE DRAWINGS

Exemplary embodiments of the present disclosure will hereinafter be described in conjunction with the following drawing figures, wherein like numerals denote like elements, and wherein:

FIG. 1 is a perspective view showing individual layers of the exemplary decorative surface laminate; and

FIG. 2 is diagram illustrating various steps in the exemplary method of the present disclosure.

### DESCRIPTION OF EXEMPLARY EMBODIMENTS AND BEST MODE

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

Referring now specifically to the drawings, the present disclosure comprises a method of manufacturing a decorative surface laminate, and a decorative surface laminate manufactured according to the exemplary method. In one embodiment, the present method is applicable for manufacturing a decorative high-pressure laminate (HPL) adapted for bonding with a substrate and incorporating in finished products such as cabinet doors, countertops, flooring, furniture and others. Except as otherwise described herein, the exemplary method employs conventional processes and techniques known the art.

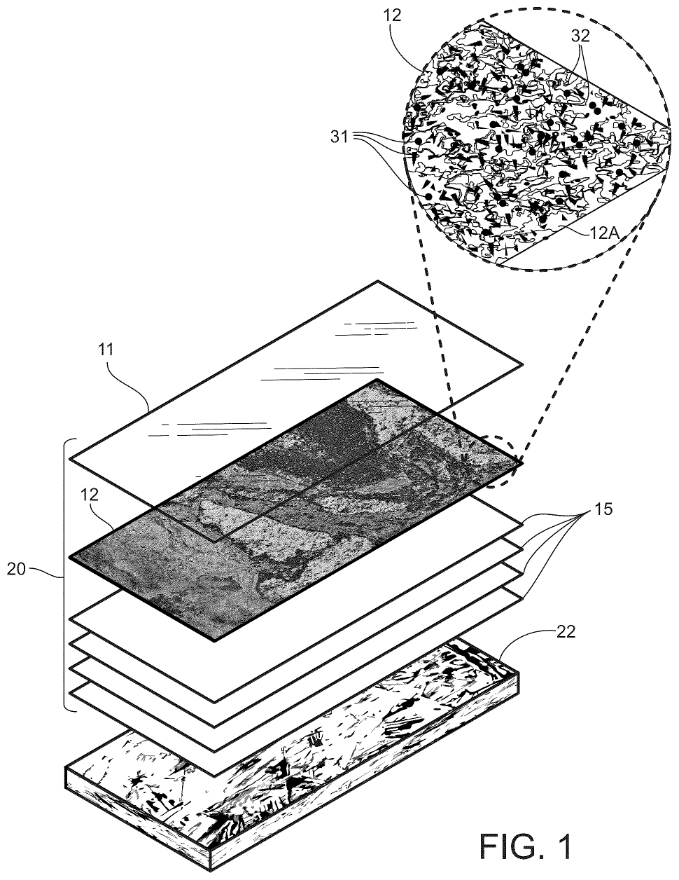

As shown in FIG. 1, the exemplary surface laminate 10 constructed according to embodiments of the present method comprises a transparent overlay 11, decorative layer 12 and 3-8 sheets of Kraft (backing) paper 15. The decorative layer 12 is a cellulose-based inclusion paper having a print surface 12A designed for digital inkjet printing. The transparent overlay 11 and inclusion paper 12 are impregnated with a thermosetting liquid resin, such as melamine-formaldehyde, while the layers of Kraft paper 15 are impregnated with a phenol-formaldehyde resin. Once impregnated and cured/dried, the layers 11, 12, 15 are cut and stacked such that the Kraft paper 15 resides adjacent the inclusion paper 12 on a side opposite the print surface. The assembled layers 11, 12, 15 are then fused together in a hydraulic press under heat and pressure to form a flexible high-density laminate panel 20. The hydraulic press simultaneously applies heat at a temperature range of between about 100 degrees C. and 150 degrees C., and pressure at a pressure range of between about 3 MPa (MegaPascal) and 8 Mpa.

The exemplary laminate panel 20 has thickness between about 0.9 and 1.0 mm and a density greater than 1.35 g/cm3. The laminate panel 20 may be formed in any desired shape and dimension including 49″×97″, 49″×121″, 61″×97″ and 61″×121″. In fabricating the end-product, the laminate panel 20 is bonded to a substrate 22 (or “base”) such as solid wood, plywood, medium-density fiberboard (MDF), high-density fiberboard (HDF), particle board, or the like. Prior to laying up on the substrate 22, the backside of the laminate panel 20 may be sanded to ensure uniform bonding and consistent thickness.

### Decorative Layer

As indicate above, the decorative layer of the present laminate 10 comprises a cellulose-based inclusion paper 12. The exemplary inclusion paper 12 is formed of cellulose fibers combined with small precision cut pieces 31 of polyurethane-coated, vacuum metallized polyester (VMPET) film—e.g., between about 10 and in some cases hundreds of individual pieces of VMPET film per square inch of paper surface area. As discussed further below, a digital inkjet printer applies a custom finish 32 directly onto the print surface 12A of the inclusion paper 12. In exemplary embodiments, the print surface 12A has a porosity greater than 1.25%, and between about 1.25% and 6.25%; and more specifically, about 2.5%. One commercial example of a suitable inclusion paper 12 is that manufactured by Onyx Specialty Papers, Inc. of Massachusetts and sold under the trademark LUSTRALITE®.

Complete specifications of an exemplary inclusion paper are provided in the following Table.

| | | Lower | Lower | | Upper | Upper |
|---|---|---|---|---|---|---|
| Specification Description | Units | Spec | Control | Target | Control | Spec |
| Basis Weight Lab | LB/3000 ft2 | 37 | | 40 | | 43 |
| Basis Weight Lab SU | LB/3000 ft2 | 37 | | 40 | | 43 |
| Basis Weight Online | LB/3000 ft2 | 37 | | 40 | | 43 |
| BW Online Variation % | % | | 0 | | 8 | |
| Caliper | INCHES | | | 0.007 | | |
| Dirt Count Rollup | COUNT | | | 1 | | 5 |
| Dirt Count Winder | COUNT | | | | | |
| Formation | RATING | 1 | | 3 | | |
| Klemm 1/16″/1 min | 1/16″/1 MIN | | | | | |
| Klemm MM/1 min | MM/1 MIN | | | | | |
| Moisture Lab | % | 2 | | 3 | | |
| pH Headbox | PH | | | | | |
| pH Hot Extract | PH | 5 | 6 | 6.5 | | 6.9 |
| Porosity 400 CC Small Hole | S/400 CC | | 5 | 10 | 25 | |
| Tear CD | GF/16PL | | | | | |
| Tear MD | GF/16PL | | | | | |
| Tensile Dry MD gf/25 mm | GF/25 MM | | | | | |
| Tensile Ratio Dry (Using gf/25 mm) | RATIO | | | | | |
| Tensile Wet CD gf/25 mm | GF/25 MM | | | | | |
| Tensile Wet MD Cured gf/2 mm | GF/25 MM | 900 | | 1550 | | |
| Tensile Wet MD gf/25 mm | GF/25 MM | 700 | | 1200 | | |

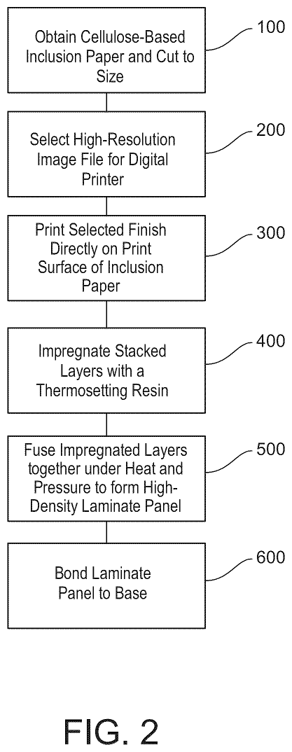

Referring to the diagram in FIG. 2, the inclusion paper described above is cut to size (Block 100) for digital printing using a conventional wide-format inkjet digital printer. Examples of suitable inkjet digital printers are those commercially available from Hewlett-Packard Company.

As known and understood in the art, inkjet printing is a non-impact printing process in which droplets of ink are deposited on a substrate, such as the inclusion paper, to form the desired image or “finish”. Inkjet printers are commonly equipped with an ink set including a cyan aqueous inkjet ink, a red aqueous inkjet ink, a yellow aqueous inkjet ink, and a black aqueous inkjet ink. Pigmented inkjet inks generally have a surface tension in the range of about 18 dyne/cm to about 35 dyne/cm at 25° C. The viscosity of the ink may be less than 30 millipascal-second at 32 degrees C. and a shear rate of 1,000 l/s (reciprocal second). In one example, the ink viscosity is between about 1 and 15 millipascal-second at 32 degrees C. and a shear rate of 1,000 l/s.

As indicated at Block 200, the digital inkjet printer receives a suitably formatted high resolution image file created and/or selected by the user. The inclusion paper is loaded into the inkjet printer which then transfers the selected digital finish directly onto the print surface of the inclusion paper. Block 300. In the exemplary embodiment, no separate (or special) ink-receiving layer or substance is required for obtaining high-resolution image quality on the inclusion paper. As previously described, the transparent overlay, printed inclusion paper and sheets of kraft paper shown in FIG. 1 are impregnated with thermosetting liquid resin. Block 400. The impregnated layers are then stacked and fused together under heat and pressure to form the flexible high-density laminate panel. Block 500. The transparent overlay applied above the print surface of the inclusion paper adds surface durability and helps protect the colored finish after printing and laminating. The laminate panel may be bonded to an underlying base (substrate) to complete the decorative surface laminate. Block 600.

Other methods for manufacturing decorative surface laminates are described in U.S. Pat. No. 11,400,701 entitled “Manufacturing of Decorative Surfaces by Inkjet.” The complete disclosure of this prior patent is incorporated herein by reference.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under 35 U.S.C. § 112(f) [or 6th paragraph/pre-AIA] is not intended. Additionally, it is not intended that the scope of patent protection afforded the present invention be defined by reading into any claim a limitation found herein that does not explicitly appear in the claim itself.

What is claimed:

1. A method of manufacturing a decorative surface laminate, comprising:
obtaining a sheet of cellulose-based inclusion paper, the inclusion paper comprising a print surface having a porosity greater than 1.25%;
digitally printing a decorative finish onto the print surface of the inclusion paper;
stacking the printed inclusion paper and multiple sheets of backing paper, such that the backing paper resides adjacent the printed inclusion paper on a side opposite the print surface;
impregnating the printed inclusion paper and backing paper with a thermosetting resin; and
using heat and pressure, combining the impregnated sheets of printed inclusion paper and backing paper to form a flexible high-density laminate panel.

2. A method of manufacturing a decorative surface laminate according to claim 1, wherein the inclusion paper comprises cellulose fibers and metallic inclusions.

3. A method of manufacturing a decorative surface laminate according to claim 2, wherein the metallic inclusions comprise cut pieces of polyurethane-coated VMPET film.

4. A method of manufacturing a decorative surface laminate according to claim 1, and comprising applying the laminate panel to a base, the base being selected from a group consisting of solid wood, plywood, medium-density fiberboard (MDF), high-density fiberboard (HDF), and particle board.

5. A method of manufacturing a decorative surface laminate according to claim 1, wherein the multiple sheets of backing paper comprise 3-8 sheets of kraft paper.

6. A method of manufacturing a decorative surface laminate according to claim 1, wherein the thermosetting resin comprises one of a group consisting of phenol-formaldehyde resin and melamine-formaldehyde resin.

7. A method of manufacturing a decorative surface laminate according to claim 1, wherein using heat and pressure comprises simultaneously applying heat at a temperature range of between 100 degrees C. and 150 degrees C., and pressure at a pressure range of between 3 MPa (MegaPascal) and 8 MPa.

8. A method of manufacturing a decorative surface laminate according to claim 1, wherein the laminate panel has a thickness less than 1.0 mm and a density greater than 1.35 g/cm3.

9. A method of manufacturing a decorative surface laminate according to claim 1, wherein the print surface of the inclusion paper has a porosity of between 1.25% and 6.25%.

10. A method of manufacturing a decorative surface laminate according to claim 1, wherein the print surface of the inclusion paper has a porosity of approximately 2.5%.

11. A method of manufacturing a decorative surface laminate according to claim 1, wherein the liquid ink has a viscosity less than 15 millipascal-second at 32 degrees C. and a shear rate of 1,000 l/s.

12. A method of manufacturing a decorative surface laminate, comprising:
obtaining a sheet of cellulose-based metallic inclusion paper, the metallic inclusion paper comprising a print surface having a porosity greater than 1.25%;
using a liquid dye-based ink, digitally printing a decorative ink finish on the print surface of the metallic inclusion paper;
stacking the printed metallic inclusion paper and the backing paper, such that the backing paper resides adjacent the printed metallic inclusion paper on a side opposite the print surface;
impregnating the printed metallic inclusion paper and backing paper with a thermosetting resin; and
using heat and pressure, combining the impregnated sheets of printed metallic inclusion paper and backing paper to form a flexible high-density laminate panel.

13. A method of manufacturing a decorative surface laminate according to claim 12, wherein the liquid dye-based ink has a viscosity less than 15 millipascal-second at 32 degrees C. and a shear rate of 1,000 l/s.

14. A method of manufacturing a decorative surface laminate according to claim 12, wherein the metallic inclusion paper comprises cellulose fibers and metallic inclusions.

15. A method of manufacturing a decorative surface laminate according to claim 14, wherein the metallic inclusions comprise cut pieces of polyurethane-coated VMPET film.

16. A method of manufacturing a decorative surface laminate according to claim 12, wherein the print surface of the metallic inclusion paper has a porosity of between 1.25% and 6.25%.

17. A method of manufacturing a decorative surface laminate, comprising:
obtaining a sheet of cellulose-based inclusion paper, the inclusion paper comprising a print surface having a porosity greater than 1.25%;
digitally printing a decorative ink finish on the print surface of the inclusion paper; and
incorporating the printed inclusion paper into a decorative surface laminate.

18. A method of manufacturing a decorative surface laminate according to claim 17, wherein the inclusion paper comprises cellulose fibers and metallic inclusions, and wherein said metallic inclusions comprise cut pieces of polyurethane-coated VMPET film.

19. A method of manufacturing a decorative surface laminate according to claim 17, wherein digitally printing comprises applying a liquid ink to the print surface of the inclusion paper, the ink having a viscosity less than 15 millipascal-second at 32 degrees C. and a shear rate of 1,000 l/s.

20. A decorative surface laminate, comprising:
a cellulose-based inclusion paper, said inclusion paper comprising a print surface having a porosity greater than 1.25%;
a digitally-printed decorative ink finish on the print surface of said inclusion paper; and
multiple sheets of backing paper stacked adjacent said inclusion paper and integrally formed with said inclusion paper under heat and pressure, such that the backing paper resides adjacent the inclusion paper on a side opposite the print surface.
